(19) United States
(12) Patent Application Publication
(10) Pub. No.: US 2024/0138374 A1
(43) Pub. Date: May 2, 2024

(54) INTERACTIVE PET TOY

(71) Applicant: T.F.H. PUBLICATIONS, INC., Neptune City, NJ (US)

(72) Inventors: Glen S. AXELROD, Colts Neck, NJ (US); Ajay GAJRIA, Monmouth Junction, NJ (US)

(21) Appl. No.: 18/496,075

(22) Filed: Oct. 27, 2023

Related U.S. Application Data
(60) Provisional application No. 63/381,153, filed on Oct. 27, 2022.

(51) Int. Cl. A01K 15/02

(52) U.S. Cl. CPC A01K 15/026

(57) ABSTRACT

An interactive pet toy to promote the focus and attention of a pet on chewing including sound feedback. The pet toy includes a body portion having a surface and one or a plurality of flexible inserts that are capable of converting into two different geometric configurations along with the generation of an audible sound. The one or plurality of inserts have in a first configuration, a projecting surface and a recessed surface, and in a second configuration, the projecting surface becomes the recessed surface and the recessed surface becomes the projecting surface.

### CROSS-REFERENCE TO RELATED APPLICATIONS

This application claims the benefit of U.S. provisional patent application Ser. No. 63/381,153, filed Oct. 27, 2022, the entire disclosure of which is incorporated herein by reference.

### FIELD

The present invention is directed at an interactive pet toy to promote the focus and attention of a pet on chewing including sound feedback.

### BACKGROUND

Dogs and other pets enjoy toys that offer a form of stimulation. For example, toys typically seek to mimic the type of stimulation that a pet might have in the wild, such as chewing on bones or other substrates. Several pet toys also seek to offer some sound producing feature that provides an auditory sensation to the animal. A need therefore remains to provide a pet toy that would promote the focus and attention of the pet on chewing and to provide sound feedback. In particular, sound feedback that will similarly promote chewing and provide a relatively durable source of sound feedback that the animal may not readily compromise through aggressive chewing behavior.

### SUMMARY

An interactive toy for an animal comprising: a body portion having a surface including one or a plurality of flexible inserts wherein the inserts are capable of converting into two different geometric configurations along with the generation of an audible sound. The one or plurality of inserts have in a first configuration, a projecting surface and a recessed surface, and in a second configuration, the projecting surface becomes the recessed surface and the recessed surface becomes the projecting surface.

An interactive toy for an animal comprising a body portion; and at least one flexible insert coupled to the body portion; wherein the at least one flexible insert is convertible into two different geometric configurations along with the generation of an audible sound; wherein the at least one flexible insert has in a first configuration, a projecting surface and a recessed surface, and in a second configuration, the projecting surface becomes the recessed surface and the recessed surface becomes the projecting surface.

In at least one embodiment, the at least one flexible insert is convertible from the first configuration to the second configuration, and then convertible from the second configuration back to the first configuration.

In at least one embodiment, the at least one flexible insert generates the audible sound when converting to the second configuration and a further audible sound when converting back to the first configuration.

In at least one embodiment, the at least one flexible insert undergoes elastic deformation when converting to the second configuration and undergoes elastic recovery when converting back to the first configuration.

In at least one embodiment the projecting surface is a hemispherical projecting surface and the recessed surface is a hemispherical recessed surface.

In at least one embodiment, the at least one flexible insert is disposed in a through-hole of the body portion.

In at least one embodiment, the body portion includes a surface that surrounds the at least one flexible insert, and a portion of the projecting surface of the at least one flexible insert extends above the surface of the body portion that surrounds the at least one flexible insert.

In at least one embodiment, the projecting surface of the at least one flexible insert extends 1.0 mm to 10.0 mm above the surface of the body portion that surrounds the at least one flexible insert.

In at least one embodiment, the projecting surface of the at least one flexible insert extends above the surface of the body portion that surrounds the at least one flexible insert in either the first configuration or the second configuration.

In at least one embodiment, the audible sound is in the range of 50 Hz to 45,000 Hz.

In at least one embodiment, the body portion comprises a thermoplastic or thermoset material. In at least one embodiment, the material is selected from polyamide, polycarbonate, polyethylene, polypropylene, polyamide, polycarbonate, polyacetal, polystyrene, polyethylene, polypropylene, polystyrene, high-impact polystyrene, polyurethanes, polyisoprene, thermoplastic elastomers, PET or PBT.

In at least one embodiment, the at least one flexible insert comprises thermoplastic elastomers or thermoset elastomers. In at least one embodiment, the elastomers comprise polyester thermoplastic elastomers, polyamide thermoplastic elastomers, polystyrene -polybutadiene elastomers, and polyisoprene based elastomers.

In at least one embodiment, the at least one flexible insert includes an attractant or a flavoring.

In at least one embodiment, the at least one flexible insert is convertible into an interim configuration and the interim configuration is convertible into one of the two different geometric configurations without an addition of force.

In at least one embodiment, a method of use of an interactive toy for an animal is provided, comprising obtaining the interactive toy for the animal, wherein the toy comprises: a body portion; and at least one flexible insert coupled to the body portion; wherein the at least one flexible insert is convertible into two different geometric configurations along with the generation of an audible sound; wherein the at least one flexible insert has in a first configuration, a projecting surface and a recessed surface, and in a second configuration, the projecting surface becomes the recessed surface and the recessed surface becomes the projecting surface; and converting the at least one flexible insert from the first configuration to the second configuration and generating the audible sound when converting to the second configuration.

In at least one embodiment, the method further comprises converting the at least one flexible insert from the second configuration back to the first configuration and generating a further audible sound when converting back to the first configuration.

### BRIEF DESCRIPTION OF THE DRAWINGS

Features and advantages of this disclosure will become more apparent as the following detailed description proceeds, and upon reference to the drawings, wherein like numerals designate like parts, and in which:

FIG. 1 is a side view of an interactive pet chew toy according to the present disclosure;

FIG. 2 is a cross-sectional view of the insert of the interactive pet chew toy of FIG. 1 taken along line A-A before force F is applied to a first side of the insert/toy;

FIG. 3 is a cross-sectional view of the insert of the interactive pet chew toy of FIG. 1 taken along line A-A during force F being applied to the first side of the insert/toy;

FIG. 4 is a cross-sectional view of the insert of the interactive pet chew toy of FIG. 1 taken along line A-A after force F is applied to the first side of the insert/toy;

FIG. 5 is a cross-sectional view of the insert of the interactive pet chew toy of FIG. 1 taken along line A-A before force F is applied to a second (opposite) side of the insert/toy;

FIG. 6 is a cross-sectional view of the insert of the interactive pet chew toy of FIG. 1 taken along line A-A during force F being applied to a second (opposite) side of the insert/toy; and

FIG. 7 is a cross-sectional view of the insert of the interactive pet chew toy of FIG. 1 taken along line A-A after force F is applied to a second (opposite) side of the insert/toy.

### DETAILED DESCRIPTION

It may be appreciated that the present disclosure is not limited in its application to the details of construction and the arrangement of components set forth in the following description or illustrated in the drawings. The invention(s) herein may be capable of other embodiments and of being practiced or being carried out in various ways. Also, it may be appreciated that the phraseology and terminology used herein is for the purpose of description and should not be regarded as limiting as such may be understood by one of skill in the art. Furthermore, throughout the present description, like reference numerals and letters indicate corresponding structure throughout the several views, and such corresponding structure need not be separately discussed. Furthermore, any particular feature(s) of a particular exemplary embodiment may be equally applied to any other exemplary embodiment(s) of this disclosure as suitable. In other words, features between the various exemplary embodiments described herein are interchangeable as suitable, and not exclusive.

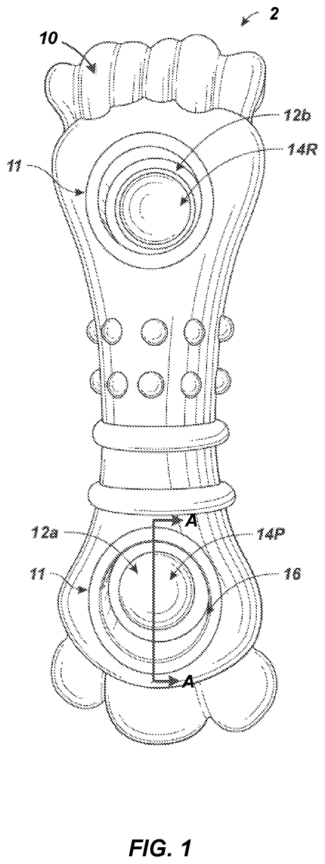

FIG. 1 provides a view of a preferred interactive pet chew toy 2 herein. As can be seen, the interactive pet toy 2, which has an elongated body portion 10 that is preferably in the form of a bone, and includes at least one, and preferably a plurality of flexible inserts 11 coupled to the body portion 10, such as being adhesively bonded to the body portion 10. More particularly, the inserts 11 are disposed in a through-hole of the body portion 10 which insert closes the through-hole. The inserts 11 are capable of assuming the configurations illustrated at 12a and 12b when chewed upon by the animal. In addition, the configurations illustrated at 12a and 12b are relatively stable configuration, meaning that they remain in such configuration unless further chewed upon by the animal. The body portion 10 is one that preferably provides separate durability to chewing.

The pet chew toy body portion 10 may preferably formed from a thermoplastic or thermoset (crosslinked) material, such as a polyamide (nylon) type resin, polycarbonate, polyacetal, polystyrene, polyethylene, polypropylene, polystyrene, high-impact polystyrene, polyurethanes (thermoplastic or thermoset), polyisoprene (e.g. natural or synthetic rubber), thermoplastic elastomers (e.g., polyester based or polyurethane based) and polyesters such as polyethylene terephthalate (PET) or polybutylene terephthalate (PBT).

The one or plurality of inserts 11 are capable of each being present in the two different and relatively stable geometric configurations shown at 12a and 12b. The inserts 11 are therefore preferably formed of material that is flexible at room temperature and capable of being deformed upon chewing action of the animal. Such flexible material may preferably be selected from thermoplastic elastomers and/or thermoset elastomers. Examples of thermoplastic elastomers include polyester thermoplastic elastomers, polyamide thermoplastic elastomers, polystyrene-polybutadiene elastomers, and natural and synthetic rubber (polyisoprene based elastomers). The inserts 11 may have a thickness in a range of 0.5 mm to 3 mm, and more particularly 0.75 mm to 2.5 mm, and even more particularly 1 mm to 2 mm.

The flexible material for the one or plurality of inserts 11 may preferably contain various additives. Such additives may include attractants or flavorings that are designed to more specifically attract the animal into engaging and chewing on the interactive pet chew. Such additives may preferably be present at a level of 0.1% (wt.) to 5.0% (wt.).

The inserts 11 are preferably such that they are each individually capable of converting, i.e. convertible, along with the generation of an audible sound, into the different geometric configurations as can be initially observed in FIG. 1, where the two insert configurations 12a and 12b are illustrated. As can therefore be seen in FIG. 1, the insert 11 in configuration 12a provides a first projecting surface 14P. Such projecting surface 14P preferably has a portion that extends above the surface of the pet chew body 10 that surrounds the insert 11 and defines the through-hole of the body portion 10. The projecting surface 14P is also one that preferably extends above the surface 16 on the perimeter of the insert 11 and that defines the through-hole of the body portion 10. Preferably, a portion of the projecting surface 14P extends 1.0 mm to 10.0 mm above the surrounding surface of the pet chew body 10 that defines the through-hole of the body portion 10, as well as above the perimeter of the insert 11. This amount of projection therefore may serve to allow the teeth of the pet, when chewing, to apply a force on the projection surface 14P, as described more fully below.

Accordingly, when a pet chews and places a force F on the projecting surface 14P of the flexible insert in configuration 12a it can convert from the first configuration 12a to the second configuration illustrated at 12b. That is, the first projecting surface 14P now becomes a recessed surface 14R and on the opposite side of the interactive pet chew toy 2, the insert 11 itself will then project on the other side of the chew with the projecting surface 14P, with the opposite side of the insert providing the projecting surface 14P. Accordingly, it can be appreciated that the one or plurality of flexible inserts 11 may now be acted upon by the animal and transition from the configuration shown in 12a to the configuration shown in 12b, and vice versa.

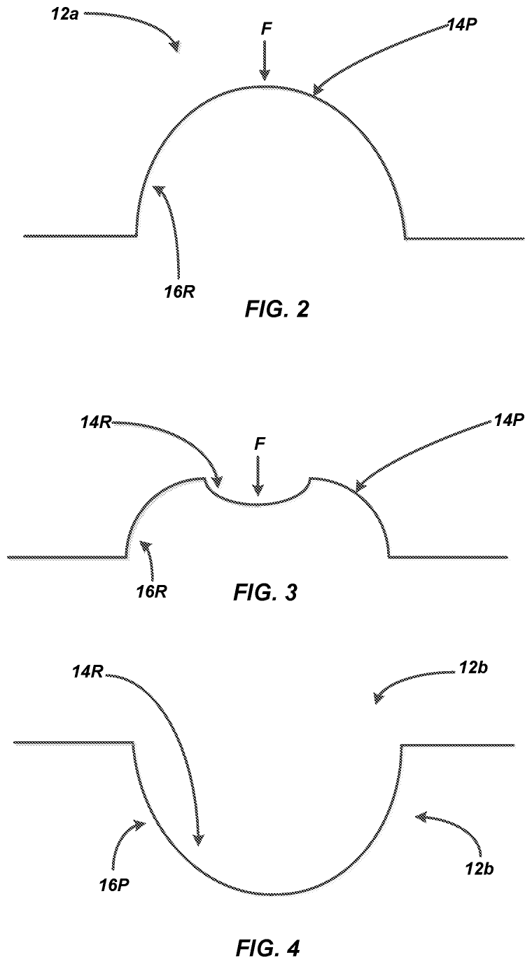

Attention is next directed to FIGS. 2-4 which illustrates in partial cross-section further details the above referenced transition in the geometry of the insert 11. As shown in FIG. 2, from a first side of the pet chew, one will see the first projecting surface 14P that as shown, preferably presents itself in a rounded-type geometry (in a form of a hemispherical dome). Other geometries are contemplated such as be ovular, ellipsoidal, polyhedral, pyramidal or any other three-dimensional shape. On the other or second side of the first projecting surface 14P one can then defined a recessed surface 16R (in a form of a hemispherical recess).

Attention is next directed to FIG. 3. Upon application of a force F to the flexible first projecting surface 14P, the insert configuration 12a begins to deform, with elastic deformation, and can also be described as inverting and transitioning towards its opposite configuration 12b. Accordingly, as shown in the interim position in FIG. 3, a portion of the first projecting surface 14P will be seen as now having a first recessed surface 14R. Then, in FIG. 4, the transition is complete, which results in the generation of an audible sound. Recessed surface 16R (FIG. 2) is now a projecting surface 16P (FIG. 4).

It is also worth noting that given the flexible nature of the insert 11, and with attention directed again at FIG. 3, the insert 11 is one that once forced into the interim configuration shown in FIG. 3, the insert 11 may on its own complete the transition without any additional force. Stated another way, the flexibility of the insert 11 and its geometry are configured such that the animal need only initiate the transition from what is shown generally in FIG. 2 to the interim position shown in FIG. 3, and the insert 11, without any additional force, can finish the transition into what is illustrated in FIG. 4, with generation of an audible sound.

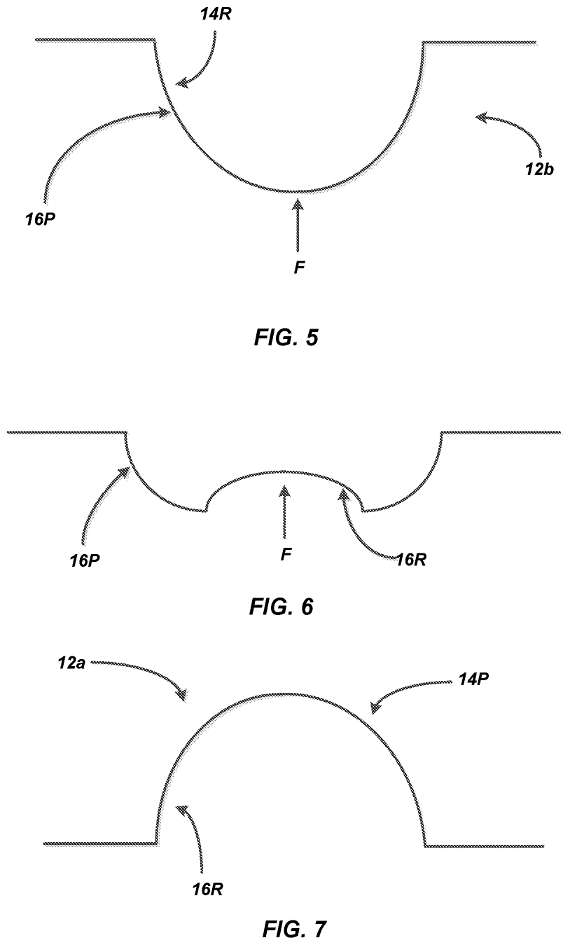

Similarly, starting with the configuration shown in FIG. 5 a force F may now again be applied by the animal during chewing to the projecting surface 16P. As shown in FIG. 6, in the interim position, as a result of such chewing, now from the other side of the pet chew, a portion of projecting surface 16P is observed converting to provide the recessed surface 16R. In FIG. 7, the transition is complete with projecting surface 14P fully reformed, i.e. elastically recovers. Moreover, as noted above, once the insert 11 is generally in the interim position illustrated in FIG. 6, it can finish the transition into what is illustrated in FIG. 7, without any additional force, along with generation of an audible sound.

As noted, the transitions illustrated in FIGS. 2-4, as well as the transition illustrated in FIGS. 5-7, are preferably accompanied by an audible sound. Such sound is relatively brief (0.1-1.0 second) and may also be described as a popping or snapping type sound. The audible sound is preferably one that can be detected by an animal, such as a dog. For example, the sound may be in a range of 50 Hz to 45 KHz (45,000 Hz). Such sound originates as the flexible insert undergoes a change in configuration from the configuration 12a shown in FIG. 2 to the configuration 12b shown in FIG. 4. Similarly, it is believed that such sound originates when the insert changes from the configuration 12b shown in FIG. 5 back into the configuration 12a shown in FIG. 7.

While a preferred embodiment of the present invention(s) has been described, it should be understood that various changes, adaptations and modifications can be made therein without departing from the spirit of the invention(s) and the scope of the appended claims. The scope of the invention(s) should, therefore, be determined not with reference to the above description, but instead should be determined with reference to the appended claims along with their full scope of equivalents. Furthermore, it should be understood that the appended claims do not necessarily comprise the broadest scope of the invention(s) which the applicant is entitled to claim, or the only manner(s) in which the invention(s) may be claimed, or that all recited features are necessary.

What is claimed is:

1. An interactive toy for an animal comprising:
a body portion; and
at least one flexible insert coupled to the body portion;
wherein the at least one flexible insert is convertible into two different geometric configurations along with the generation of an audible sound;
wherein the at least one flexible insert has in a first configuration, a projecting surface and a recessed surface, and in a second configuration, the projecting surface becomes the recessed surface and the recessed surface becomes the projecting surface.

2. The interactive toy for an animal of claim 1, wherein the at least one flexible insert is convertible from the first configuration to the second configuration, and then convertible from the second configuration back to the first configuration.

3. The interactive toy for an animal of claim 2, wherein the at least one flexible insert generates the audible sound when converting to the second configuration and a further audible sound when converting back to the first configuration.

4. The interactive toy for an animal of claim 2, wherein the at least one flexible insert undergoes elastic deformation when converting to the second configuration and undergoes elastic recovery when converting back to the first configuration.

5. The interactive toy for an animal of claim 1, wherein the projecting surface is a hemispherical projecting surface, and the recessed surface is a hemispherical recessed surface.

6. The interactive toy for an animal of claim 1, wherein the at least one flexible insert is disposed in a through-hole of the body portion.

7. The interactive toy for an animal of claim 1, wherein the body portion includes a surface that surrounds the at least one flexible insert, and a portion of the projecting surface of the at least one flexible insert extends above the surface of the body portion that surrounds the at least one flexible insert.

8. The interactive toy for an animal of claim 7, wherein the projecting surface of the at least one flexible insert extends 1.0 mm to 10.0 mm above the surface of the body portion that surrounds the at least one flexible insert.

9. The interactive toy for an animal of claim 7, wherein the projecting surface of the at least one flexible insert extends above the surface of the body portion that surrounds the at least one flexible insert in either the first configuration or the second configuration.

10. The interactive toy for an animal of claim 1, wherein the audible sound is in the range of 50 Hz to 45,000 Hz.

11. The interactive toy for an animal of claim 1, wherein the body portion comprises a thermoplastic or thermoset material.

12. The interactive toy for an animal of claim 11, wherein the material is selected from polyamide, polycarbonate, polyethylene, polypropylene, polyamide, polycarbonate, polyacetal, polystyrene, polyethylene, polypropylene, polystyrene, high-impact polystyrene, polyurethanes, polyisoprene, thermoplastic elastomers, PET or PBT.

13. The interactive toy for an animal of claim 1, wherein the at least one flexible insert comprises thermoplastic elastomers or thermoset elastomers.

14. The interactive toy for an animal of claim 13, wherein the elastomers comprise polyester thermoplastic elastomers, polyamide thermoplastic elastomers, polystyrene -polybutadiene elastomers, and polyisoprene based elastomers.

15. The interactive toy for an animal of claim 1, wherein the at least one flexible insert includes an attractant or a flavoring.

16. The interactive toy for an animal of claim 1, wherein the at least one flexible insert is convertible into an interim configuration and the interim configuration is convertible into one of the two different geometric configurations without an addition of force.

17. A method of use of an interactive toy for an animal, comprising:
obtaining the interactive toy for the animal, wherein the toy comprises:
a body portion; and
at least one flexible insert coupled to the body portion;
wherein the at least one flexible insert is convertible into two different geometric configurations along with the generation of an audible sound;
wherein the at least one flexible insert has in a first configuration, a projecting surface and a recessed surface, and in a second configuration, the projecting surface becomes the recessed surface and the recessed surface becomes the projecting surface; and
converting the at least one flexible insert from the first configuration to the second configuration and generating the audible sound when converting to the second configuration.

18. The method of claim 17, further comprising:
converting the at least one flexible insert from the second configuration back to the first configuration and generating a further audible sound when converting back to the first configuration.
